(19) United States
(12) Patent Application Publication
(10) Pub. No.: US 2025/0335704 A1
(43) Pub. Date: Oct. 30, 2025

(54) SYSTEMS AND METHODS FOR SUPPLEMENTING PROMPTS FOR A LARGE LANGUAGE MODEL WITH BIOMETRIC-BASED INTENT DATA

(71) Applicant: Verizon Patent and Licensing Inc., Basking Ridge, NJ (US)

(72) Inventors: Viraj Chandrakant MANTRI, Hyderabad (IN); Pankaj RAI, Mania Mirzabad (IN); Srividhya PARTHASARATHY, Chennai (IN); Nainar MOHAMED, Chennai (IN); Jagadeesh BALASUBRAMANIAN, Chennai (IN)

(73) Assignee: Verizon Patent and Licensing Inc., Basking Ridge, NJ (US)

(21) Appl. No.: 18/646,001

(22) Filed: Apr. 25, 2024

(51) Int. Cl. G06F 40/20; G06F 3/01; H04L 67/306

(52) U.S. Cl. CPC G06F 40/20; G06F 3/013; H04L 67/306

(57) ABSTRACT

A user device may receive a user interface that includes content, and may provide the user interface for display to a user of the user device. The user device may receive a user interaction with the user interface, and may calculate, based on the user interaction, gaze data identifying a gaze of the user, a dwell time of the gaze, and an eye behavior of the user relative to the content. The user device may generate intent data based on the gaze data, and may provide the intent data and one or more prompts to a large language model (LLM) system. The user device may receive one or more responses from the LLM system based on providing the intent data and the one or more prompts to the LLM system.

### BACKGROUND

The field of human-computer interaction includes systems that facilitate communication between users and user devices (e.g., communication and/or computing devices). Advancements in this field include the creation and refinement of large language models (LLMs) that process and respond to user inputs in a manner that is intended to be contextually appropriate.

### BRIEF DESCRIPTION OF THE DRAWINGS

FIGS. 1A-1H are diagrams of an example associated with supplementing prompts for an LLM with biometric-based intent data.

FIG. 2 is a diagram of an example environment in which systems and/or methods described herein may be implemented.

FIG. 3 is a diagram of example components of one or more devices of FIG. 2.

FIG. 4 is a flowchart of an example process for supplementing prompts for an LLM with biometric-based intent data.

### DETAILED DESCRIPTION OF EXAMPLE EMBODIMENTS

The following detailed description of example implementations refers to the accompanying drawings. The same reference numbers in different drawings may identify the same or similar elements.

LLMs have revolutionized the field of artificial intelligence by providing advanced capabilities for generating human-like responses to questions. LLMs rely on carefully constructed prompts to elicit specific outputs, solutions, and/or actions based on a received input. Currently, LLMs are unable to understand user intent since LLMs predominantly process textual, audio, or visual frame prompts. Thus, LLMs fail to accurately capture the nuances of user intent, especially when a user may struggle to articulate needs through explicit prompts. Furthermore, the integration of LLMs into various applications, such as integrated development environments (IDEs) used for software development, requires users to be explicit and precise in their input prompts to obtain useful assistance from LLMs. This often depends on a user's ability to clearly articulate issues, which can be a barrier to efficient problem-solving, particularly when the user finds it difficult to express their intent in words or when the LLM misinterprets the user's needs. Consequently, there is a gap between the user's actual intent and an understanding of an LLM, which can lead to suboptimal interactions and outputs from the LLM.

Thus, current techniques for utilizing LLMs may consume computing resources (e.g., processing resources, memory resources, communication resources, and/or the like), networking resources, and/or other resources associated with LLMs failing to properly assist a user with content being viewed by the user, LLMs providing incorrect recommendations to a user viewing content based on failing to understand the user's intent, LLMs failing to interpret user intent and providing irrelevant and inaccurate responses based on failing to interpret user intent, and/or the like.

Some implementations described herein provide a user device that supplements prompts for an LLM with biometric-based intent data. For example, the user device may receive a user interface that includes content, and may provide the user interface for display to a user of the user device. The user device may receive a user interaction with the user interface, and may calculate, based on the user interaction, gaze data identifying a gaze of the user, a dwell time of the gaze, and an eye behavior of the user relative to the content. The user device may generate intent data based on the gaze data, and may provide the intent data and one or more prompts to a large language model (LLM) system. The user device may receive one or more responses from the LLM system based on providing the intent data and the one or more prompts to the LLM system.

In this way, the user device supplements prompts for an LLM with biometric-based intent data. For example, the user device may analyze gaze data identifying a location of a gaze of a user, a dwell time of the gaze, and a pupil behavior of the user relative to content displayed by the user device. The user device may generate, based on the gaze data, intent data reflecting the user's action or behavioral intents, and may provide the intent data to an LLM to supplement input prompts from the user. The LLM may utilize the intent data to generate responses to the input prompts that are more aligned with the user intent, and may provide the responses to the user device. The user device provides a technical advancement in the field of human-computer interaction by enabling LLMs to interpret non-verbal user inputs, thereby reducing computational overhead associated with processing verbose and potentially ambiguous verbal or textual prompts. This may reduce processing time by LLMs, may increase efficiencies of LLMs, may reduce latency in response generation, and/or the like. Thus, the user device may conserve computing resources, networking resources, and/or other resources that would have otherwise been consumed by LLMs failing to properly assist a user with content being viewed by the user, LLMs providing incorrect recommendations to a user viewing content based on failing to understand the user's intent, LLMs failing to interpret user intent and providing irrelevant and inaccurate responses based on failing to interpret user intent, and/or the like.

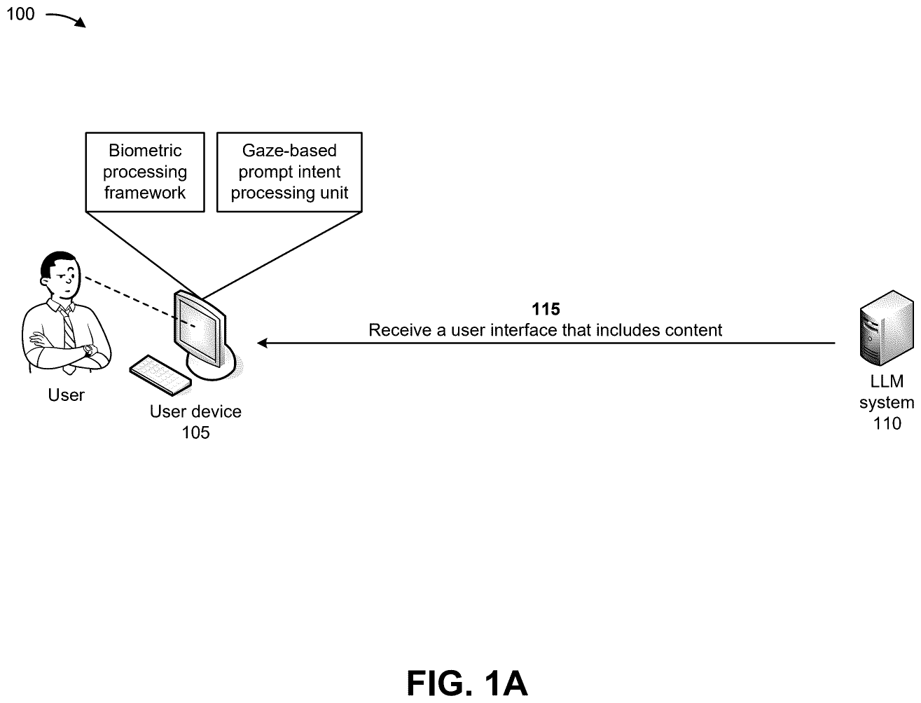

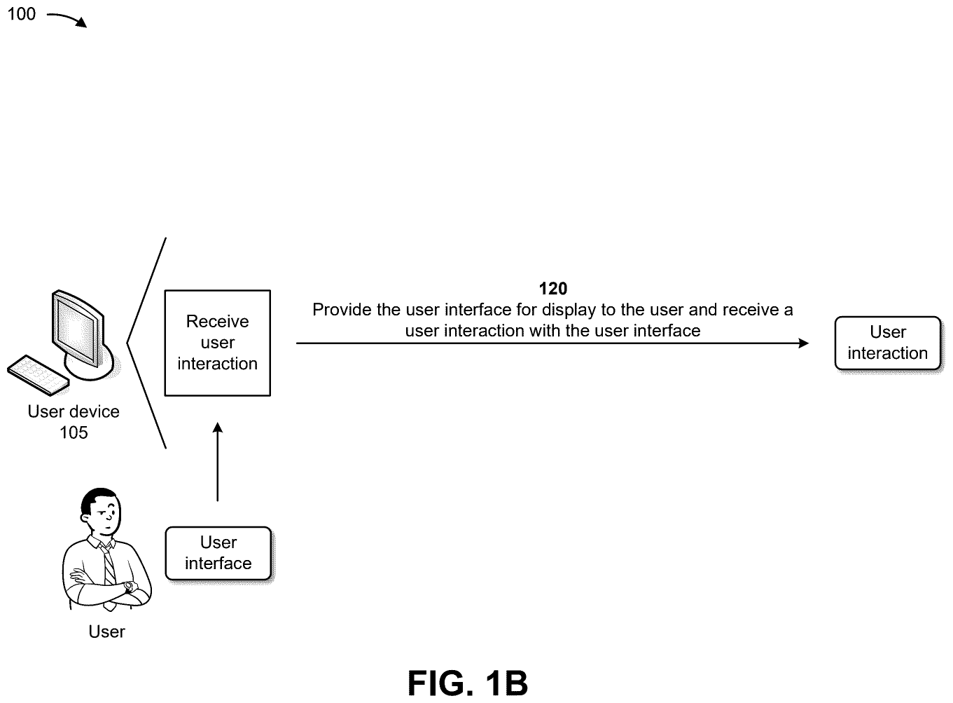

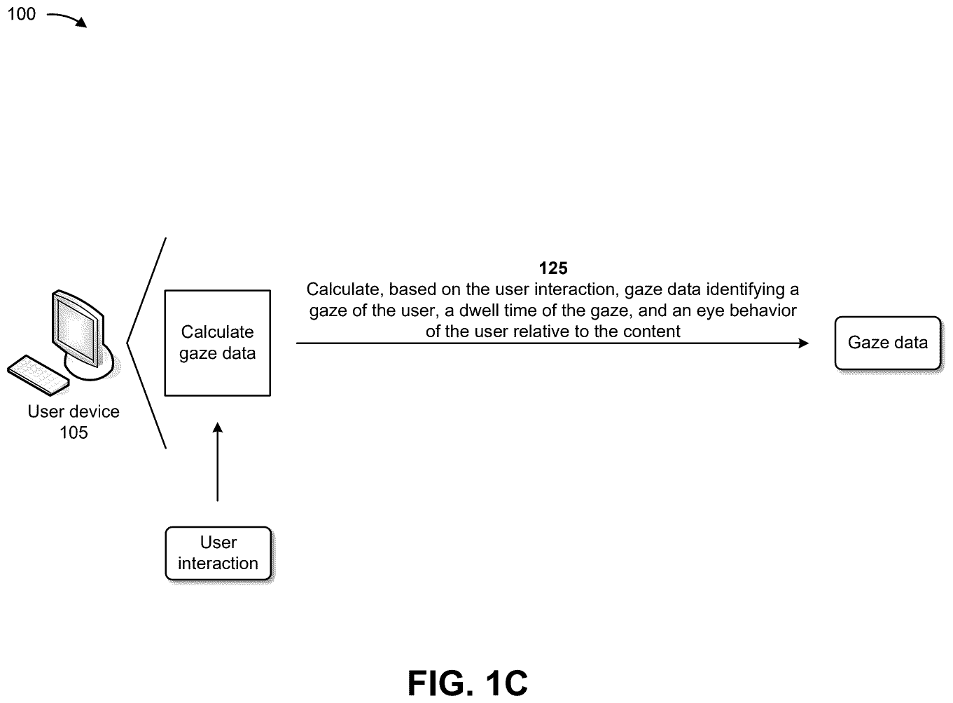

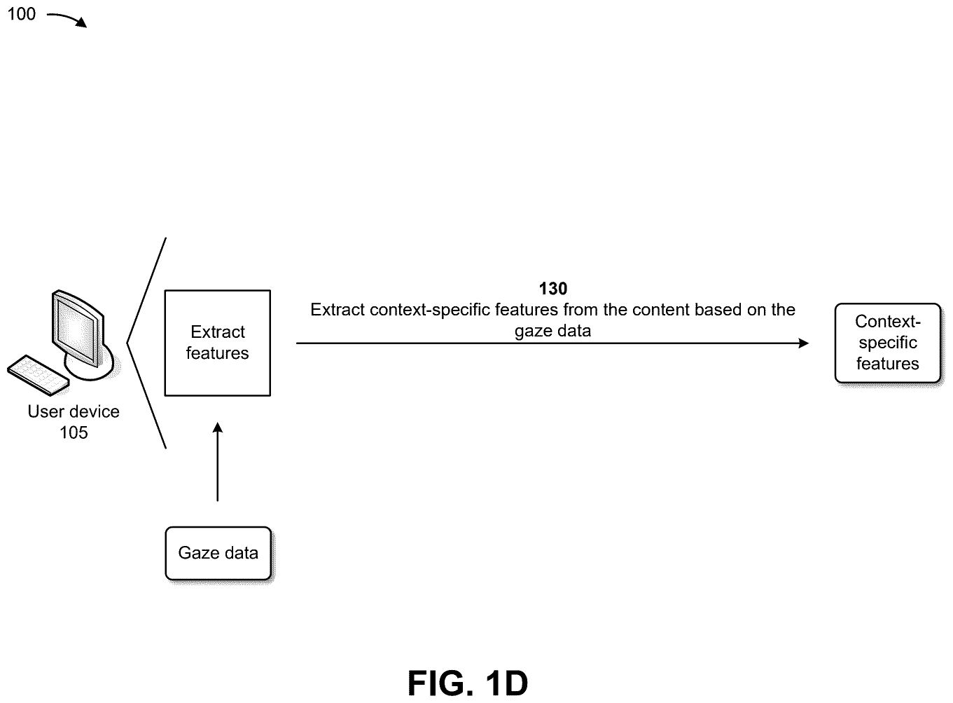

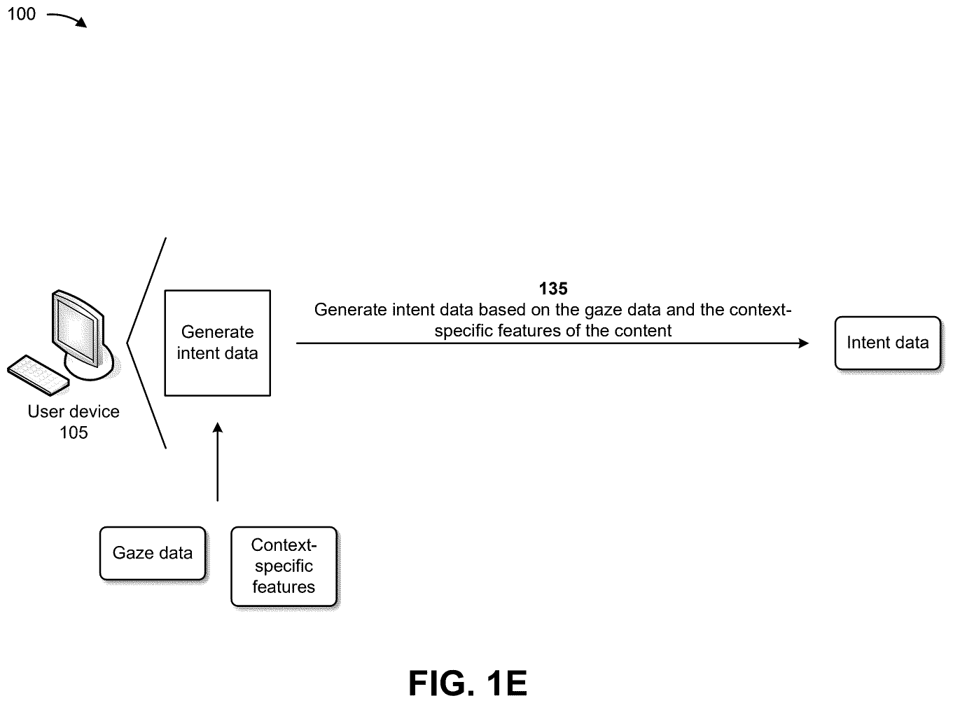

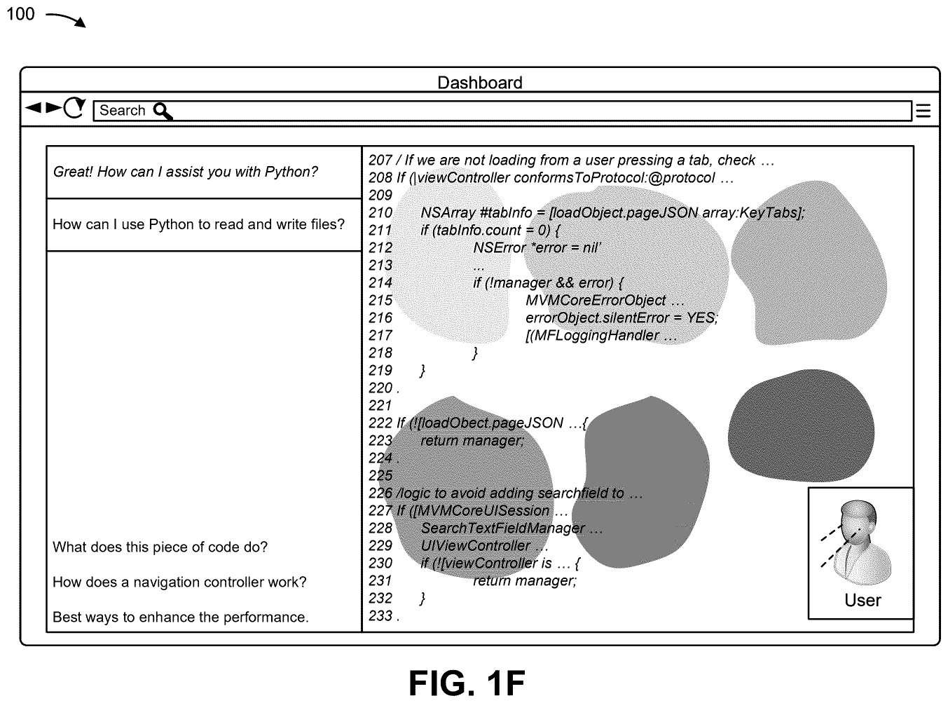

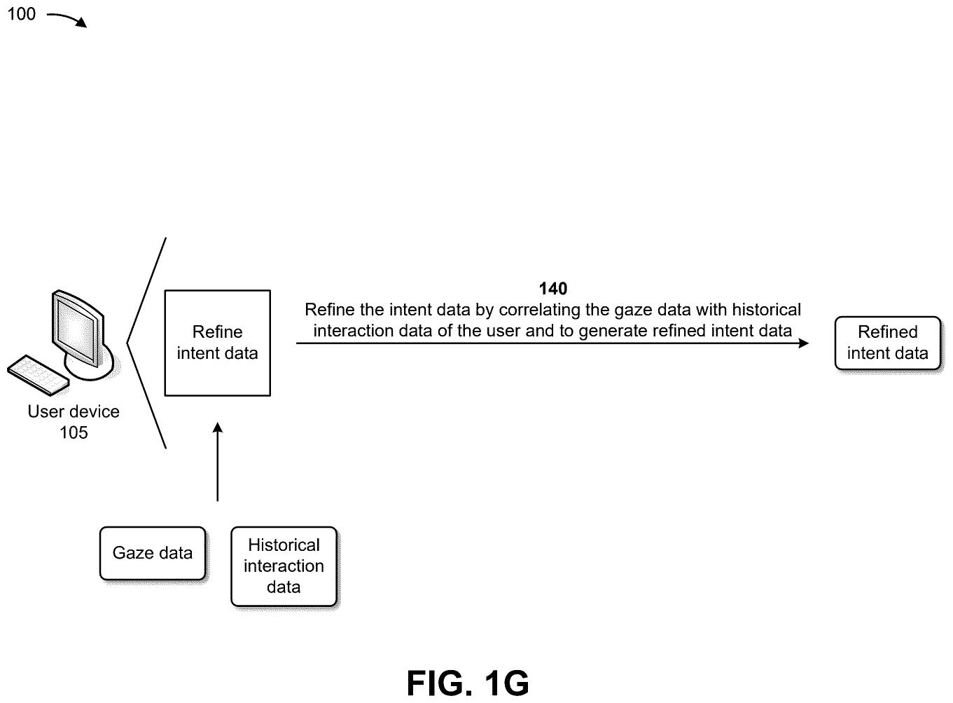

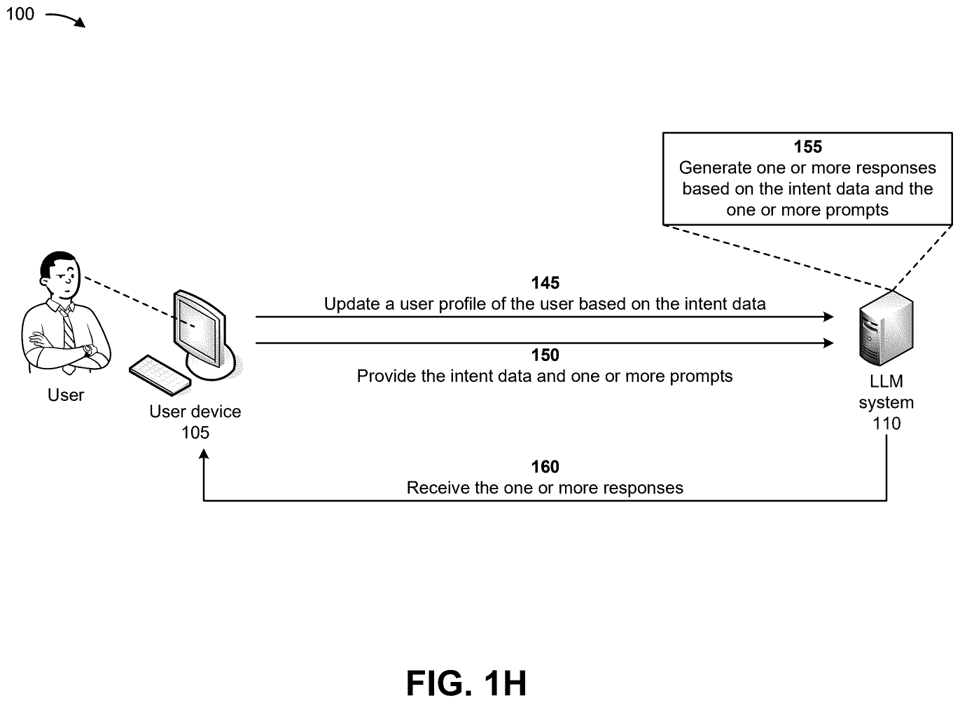

FIGS. 1A-1H are diagrams of an example 100 associated with supplementing prompts for an LLM with biometric-based intent data. As shown in FIGS. 1A-1H, example 100 includes a user device 105 associated with a user and an LLM system 110. In some implementations, a camera may be included in the user device 105, separate from the user device 105, and/or the like. Further details of the user device 105 and the LLM system 110 are provided elsewhere herein.

As shown in FIG. 1A, the user device 105 may include a biometric processing framework and a gaze-based prompt intent processing unit. The biometrics processing framework may provide functions, such as face landmark detection, determination of a point viewed by the user, determination of a duration that the point is viewed by the user, capture of eye expressions of the user, and/or the like. The gaze-based prompt intent processing unit may receive biometric inputs from the biometric processing framework, and may determine meaningful insights (e.g., action or behavior intents of the user, view intents of the user, weights allocated to the intents, and/or the like) for use by an LLM.

As further shown in FIG. 1A, and by reference number 115, the user device 105 may receive a user interface that includes content. For example, the user device 105 may receive the user interface with the content from the LLM system 110. Alternatively, the user device 105 may generate the user interface with the content or may receive the user interface with the content from a device other than the LLM system 110. In some implementations, the user device 105 may be associated with an integrated development environment used for software development and maintenance. The integrated development environment may provide the user interface with the content to the user device 105, and the user device 105 may receive the user interface with the content from the integrated development environment. The integrated development environment may communicate with the LLM system 110 to solve and assist the user (e.g., a developer) of the user device 105 in effective coding and development practices. For example, the LLM system 110 may aid in identifying runtime and logical issues with a specific block of code, refactoring and cleaning up code to improve performance, rectifying syntactical and compiler errors, writing unit test cases for different files and/or functions of code, understanding code unknown to the user, and/or the like.

As shown in FIG. 1B, and by reference number 120, the user device 105 may provide the user interface for display to the user and receive a user interaction with the user interface. For example, the user device 105 may provide the user interface with content on a display of the user device 105, and the user may view the user interface with the content via the display. In some implementations, the user may utilize the user device 105 to interact with the user interface, and the user device 105 may receive the user interaction. The user interaction may include the user touching a portion (e.g., the content) of the user interface with a finger gesture (e.g., if the user device 105 includes a touch screen display), the user gazing at the content of the user interface (e.g., as captured by a camera associated with the user device 105), the user utilizing an input device (e.g., a mouse) of the user device 105 to point at a portion (e.g., the content) of the user interface, and/or the like.

As shown in FIG. 1C, and by reference number 125, the user device 105 may calculate, based on the user interaction, gaze data identifying a gaze of the user, a dwell time of the gaze, and an eye behavior of the user relative to the content. For example, the biometrics processing framework of the user device 105 may detect a face of the user based on the user interaction, may determine a point viewed by the user based on the user interaction, may determine a duration that the point is viewed by the user, may capture eye expressions of the user based on the user interaction, and/or the like. The biometrics processing framework of the user device 105 may capture and process various aspects of the user's gaze, such as an exact location on a display screen where the user is looking, an amount of time that the user's gaze remains on a particular area (e.g., a dwell time), and the user's pupil behavior, which may include dilation or constriction in response to the content displayed on the user device 105. In some aspects, the biometrics processing framework of the user device 105 may calibrate a gaze tracking model based on an initial user interaction with the user device 105. For example, the biometrics processing framework may utilize initial calibration sessions to fine-tune the gaze tracking model, ensuring accurate tracking of the user's gaze throughout subsequent user interactions with the user device 105.

In some implementations, the biometrics processing framework of the user device 105 may calculate coordinates of a right pupil of the user according to: x=eye_right.origin[0]+eye_right.pupil.x, and y=eye_right.origin [1]+eye_right.pupil.y, and may calculate coordinates of a left pupil of the user according to: x=eye_left.origin [0]+eye_left.pupil.x, and y=eye_left.origin [1]+eye_left.pupil.y. The biometrics processing framework of the user device 105 may calculate mean coordinates of the left and right pupils of the user according to: x=(self.eye_left.origin [0]+self.eye_left.pupil.x+self.eye_right.origin [0]+self.eye_right.pupil.x)/2, and y=(self.eye_left.origin [1]+self.eye_left.pupil.y+self.eye_right.origin [1]+self.eye_right.pupil.y)/2.

The biometrics processing framework of the user device 105 may calculate a horizontal ratio of given coordinates (e.g., a number between 0.0 and 1.0 which indicates a direction of the gaze with respect to the content, where 0.0 is extreme left, 0.5 is center, and 1.0 is extreme right) according to: pupil_left=self.eye_left.pupil.x/(self.eye_left.center[0]*2-10), pupil_right=self.eye_right.pupil.x/(self.eye_right.center[0]*2-10), and Horizontal_ratio=(pupil_left+pupil_right)/2. The biometrics processing framework of the user device 105 may calculate a vertical ratio of given coordinates (e.g., a number between 0.0 and 1.0 which indicates a direction of the gaze with respect to the content, where 0.0 is extreme top, 0.5 is center, and 1.0 is extreme bottom) according to: pupil_left=self.eye_left.pupil.y/(self.eye_left.center [1]*2-10), pupil_right=self.eye_right.pupil.y/(self.eye_right.center [1]*2-10), and Vertical_ratio=(pupil_left+pupil_right)/2.

The biometrics processing framework of the user device 105 may calculate a midpoint of the left pupil and the right pupil according to: x, y=((pupil_leftX+pupil_rightX)/2), ((pupil_leftY+pupil_rightY)/2). The biometrics processing framework of the user device 105 may calculate a head direction and a deviation from a center position and may translate to a midpoint according to: xv, yv=x+hfx, y+hfy, where hf is a head directional factor. The biometrics processing framework of the user device 105 may translate points xv and yv with a z value identified by a depth estimation such that view coordinates on the display (xview, yview) may be identified.

As shown in FIG. 1D, and by reference number 130, the user device 105 may extract context-specific features from the content based on the gaze data. For example, based on the gaze data, the biometrics processing framework of the user device 105 may identify key elements (e.g., context-specific features) of the content on which the user focuses, such as specific code blocks, error messages, user interface elements, and/or the like. The user device 105 may utilize the context-specific features to enhance a relevance of intent data generated by the gaze-based prompt intent processing unit of the user device 105 (e.g., as described below). In some implementations, the biometrics processing framework of the user device 105 may determine a sequence of user focus areas on the content to enhance the accuracy of the intent data generated by the gaze-based prompt intent processing unit of the user device 105. For example, by tracking the user's gaze path across different content areas, the gaze-based prompt intent processing unit of the user device 105 may infer a logical flow of the user's thought process and may refine the intent data accordingly.

As shown in FIG. 1E, and by reference number 135, the user device 105 may generate intent data based on the gaze data and the context-specific features of the content. For example, the gaze-based prompt intent processing unit of the user device 105 may interpret the user's gaze patterns (e.g., the gaze data and/or the context-specific features) to infer action or behavioral intents of the user, such as whether the user is seeking information associated with the content, troubleshooting an error associated with the content, exploring different sections of the content, and/or the like. The intent data may provide a deeper understanding of the user's objectives and can be used to tailor the user experience.

In some implementations, the gaze-based prompt intent processing unit of the user device 105 may adjust the intent data based on a detected change in the user's pupil behavior over time. For example, if the biometrics processing framework of the user device 105 notices a change in pupil dilation, which may indicate increased cognitive load or emotional response, the gaze-based prompt intent processing unit of the user device 105 may update the intent data to reflect these new insights into the user's state of mind. In some implementations, the gaze-based prompt intent processing unit of the user device 105 may prioritize multiple intents within the intent data based on a predetermined weighting system. For example, the gaze-based prompt intent processing unit of the user device 105 may assign different weights to various intents based on factors, such as a frequency of gaze fixation on certain content elements (e.g., a top k frequent elements) or the intensity of the pupil response (e.g., eye expressions and behavior), thereby prioritizing the most significant intents for further processing. While multiple intents of the intent data may be generated in milliseconds, the weights may be a differentiating factor on an importance of an intent or may be utilized to prioritize the multiple intents.

In some implementations, the gaze-based prompt intent processing unit of the user device 105 may generate intent data that includes action and/or behavior intents or view intents. An example of action/behavior intents may include a developer using an integrated development environment, as shown in FIG. 1F. The developer may encounter errors and may look at content that shows the error, a line or a block of code that could possibly be responsible for the error, and/or the like. Such actions and behaviors of the user may cause the gaze-based prompt intent processing unit of the user device 105 to generate an intent that the user is looking to solve the error. The LLM system 110 may utilize such action/behavior intents to identify a variety of information, such as possible issues (e.g., logical issues, run time issues, or configuration issues) that cause the error, possible solutions to the possible issues, and/or the like. Thus, the action/behavior intents enable the LLM system 110 to generate more insights for an accurate solution. An example of view intents may include a developer continuously looking at a code branch or source details and shuffling between various buttons on a menu bar of the integrated development environment. Such views by the developer may cause the gaze-based prompt intent processing unit of the user device 105 to generate view intents, such as doubts or concerns regarding version control settings, queries regarding project settings, and/or the like. Different views by the user across multiple entities on the user interface may cause the gaze-based prompt intent processing unit of the user device 105 to generate the view intents. The LLM system 110 may utilize such view intents to accurately answer and propose options to the user's issues and concerns.

As shown in FIG. 1G, and by reference number 140, the user device 105 may refine the intent data by correlating the gaze data with historical interaction data of the user and to generate refined intent data. For example, by analyzing past interactions, the user device 105 may identify patterns and preferences unique to the user, and may utilize the patterns and preferences to generate more accurate predictions about the user's current intents. In some implementations, the user device 105 may generate an alert when the intent data indicates a potential error in the user interaction with the content. For example, if the user device 105 detects a prolonged focus on an error message or a section of code with known issues, the user device 105 may trigger an alert to prompt the user to review the content or to request assistance.

In some implementations, the user device 105 may modify the intent data in response to real-time feedback from the LLM system 110. For example, if the LLM system 110 provides feedback that suggests a misunderstanding of the user's intent, the user device 105 may adjust the intent data to better align with the user's actual needs. In some implementations, the user device 105 may associate emotional states of the user with the intent data based on an analysis of pupil behavior of the user. For example, changes in pupil size of the user may indicate emotional reactions, such as frustration or confusion, and the user device 105 may factor the emotional reactions into the intent data to provide a more nuanced understanding of the user's state.

As shown in FIG. 1H, and by reference number 145, the user device 105 may update a user profile of the user based on the intent data. For example, the user device 105 may maintain a user profile of the user and/or the LLM system 110 may maintain the user profile of the user. The user device 105 may update the user profile with the intent data. By incorporating the intent data into the user profile, the user device 105 may tailor responses from the LLM system 110 to better match the user's preferences and interaction history. In some implementations, the user device 105 may filter irrelevant gaze data to focus on significant user interactions with the content. For example, the user device 105 may disregard random or brief gaze fixations that do not contribute to understanding the user's intent, thereby streamlining an analysis process for the user device 105.

As further shown in FIG. 1H, and by reference number 150, the user device 105 may provide the intent data and one or more prompts to the LLM system 110. For example, the user may cause the user device 105 to generate one or more prompts for the LLM system 110, and may cause the user device 105 to provide the intent data and the one or more prompts to the LLM system 110. Each of the one or more prompts may include instructions, context, input data, output indicators, and/or the like. By providing the LLM system 110 with the intent data, the user device 105 may enhance an ability of the LLM system 110 to generate responses that are more aligned with the user's actual needs and expectations, leading to improved accuracy and user satisfaction.

As further shown in FIG. 1H, and by reference number 155, the LLM system 110 may generate one or more responses based on the intent data and the one or more prompts. For example, the LLM system 110 may pass the intent data and the one or more prompts to an LLM, and the LLM may generate the one or more responses based on the intent data and the one or more prompts. In some implementations, the one or more responses may be associated with software development, dynamic customer journey calibration, generating next best actions, and/or the like. When generating the one or more responses, the intent data may enable the LLM to reduce a quantity of iterative refinements, keep feedback loops simple and lean, and make accurate predictions by using simple and openly curated intents.

As further shown in FIG. 1H, and by reference number 160, the user device 105 may receive the one or more responses from the LLM system 110. For example, the LLM system 110 may provide the one or more responses to the user device 105, and the user device 105 may receive the one or more responses from the LLM system 110. The user device 105 may display one or more responses to the user or may audibly provide the one or more responses to the user. The user may utilize the one or more responses to improve software code, address a software error, write new software code, and/or the like.

In this way, the user device 105 supplements prompts for an LLM with biometric-based intent data. For example, the user device 105 may analyze gaze data identifying a location of a gaze of a user, a dwell time of the gaze, and a pupil behavior of the user relative to content displayed by the user device. The user device 105 may generate, based on the gaze data, intent data reflecting the user's action or behavioral intents, and may provide the intent data to an LLM to supplement input prompts from the user. The LLM may utilize the intent data to generate responses to the input prompts that are more aligned with the user intent, and may provide the responses to the user device. The user device 105 provides a technical advancement in the field of human-computer interaction by enabling LLMs to interpret non-verbal user inputs, thereby reducing computational overhead associated with processing verbose and potentially ambiguous verbal or textual prompts. This may reduce processing time by LLMs, may increase efficiencies of LLMs, may reduce latency in response generation, and/or the like. Thus, the user device 105 may conserve computing resources, networking resources, and/or other resources that would have otherwise been consumed by LLMs failing to properly assist a user with content being viewed by the user, LLMs providing incorrect recommendations to a user viewing content based on failing to understand the user's intent, LLMs failing to interpret user intent and providing irrelevant and inaccurate responses based on failing to interpret user intent, and/or the like.

As indicated above, FIGS. 1A-1H are provided as an example. Other examples may differ from what is described with regard to FIGS. 1A-1H. The number and arrangement of devices shown in FIGS. 1A-1H are provided as an example. In practice, there may be additional devices, fewer devices, different devices, or differently arranged devices than those shown in FIGS. 1A-1H. Furthermore, two or more devices shown in FIGS. 1A-1H may be implemented within a single device, or a single device shown in FIGS. 1A-1H may be implemented as multiple, distributed devices. Additionally, or alternatively, a set of devices (e.g., one or more devices) shown in FIGS. 1A-1H may perform one or more functions described as being performed by another set of devices shown in FIGS. 1A-1H.

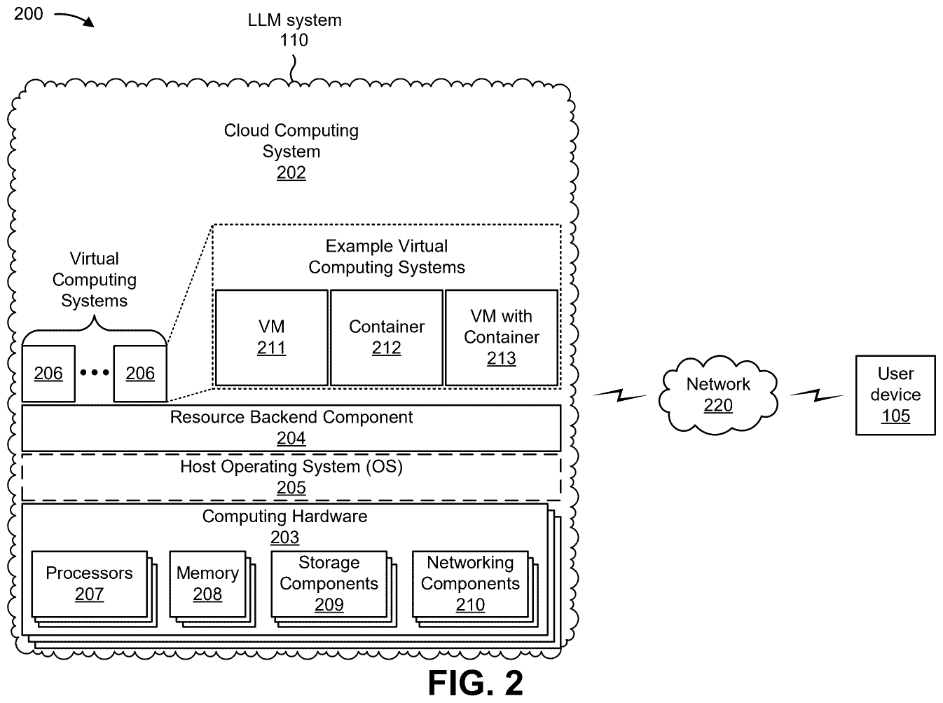

FIG. 2 is a diagram of an example environment 200 in which systems and/or methods described herein may be implemented. As shown in FIG. 2, the environment 200 may include the LLM system 110, which may include one or more elements of and/or may execute within a cloud computing system 202. The cloud computing system 202 may include one or more elements 203-213, as described in more detail below. As further shown in FIG. 2, the environment 200 may include the user device 105 and/or a network 220. Devices and/or elements of the environment 200 may interconnect via wired connections and/or wireless connections.

The user device 105 may include one or more devices capable of receiving, generating, storing, processing, and/or providing information, as described elsewhere herein. The user device 105 may include a communication device and/or a computing device. For example, the user device 105 may include a wireless communication device, a mobile phone, a user equipment, a laptop computer, a tablet computer, a desktop computer, a gaming console, a set-top box, a wearable communication device (e.g., a smart wristwatch, a pair of smart eyeglasses, a head mounted display, or a virtual reality headset), a virtual assistant device, or a similar type of device.

In some implementations, the user device 105 may include a camera capable of receiving, generating, storing, processing, providing, and/or routing information, as described elsewhere herein. The camera may include a communication device and/or a computing device. For example, the camera may include an optical instrument that captures images, audio, and/or videos (e.g., images and audio). The camera may feed real-time images and/or video directly to the user device 105 or the display of the user device 105, may record captured images and/or video to a storage device for archiving or further processing, and/or the like.

The cloud computing system 202 includes computing hardware 203, a resource management component 204, a host operating system (OS) 205, and/or one or more virtual computing systems 206. The cloud computing system 202 may execute on, for example, an Amazon Web Services platform, a Microsoft Azure platform, or a Snowflake platform. The resource management component 204 may perform virtualization (e.g., abstraction) of the computing hardware 203 to create the one or more virtual computing systems 206. Using virtualization, the resource management component 204 enables a single computing device (e.g., a computer or a server) to operate like multiple computing devices, such as by creating multiple isolated virtual computing systems 206 from the computing hardware 203 of the single computing device. In this way, the computing hardware 203 can operate more efficiently, with lower power consumption, higher reliability, higher availability, higher utilization, greater flexibility, and lower cost than using separate computing devices.

The computing hardware 203 includes hardware and corresponding resources from one or more computing devices. For example, the computing hardware 203 may include hardware from a single computing device (e.g., a single server) or from multiple computing devices (e.g., multiple servers), such as multiple computing devices in one or more data centers. As shown, the computing hardware 203 may include one or more processors 207, one or more memories 208, one or more storage components 209, and/or one or more networking components 210. Examples of a processor, a memory, a storage component, and a networking component (e.g., a communication component) are described elsewhere herein.

The resource management component 204 includes a virtualization application (e.g., executing on hardware, such as the computing hardware 203) capable of virtualizing computing hardware 203 to start, stop, and/or manage one or more virtual computing systems 206. For example, the resource management component 204 may include a hypervisor (e.g., a bare-metal or Type 1 hypervisor, a hosted or Type 2 hypervisor, or another type of hypervisor) or a virtual machine monitor, such as when the virtual computing systems 206 are virtual machines 211. Additionally, or alternatively, the resource management component 204 may include a container manager, such as when the virtual computing systems 206 are containers 212. In some implementations, the resource management component 204 executes within and/or in coordination with a host operating system 205.

A virtual computing system 206 includes a virtual environment that enables cloud-based execution of operations and/or processes described herein using the computing hardware 203. As shown, the virtual computing system 206 may include a virtual machine 211, a container 212, or a hybrid environment 213 that includes a virtual machine and a container, among other examples. The virtual computing system 206 may execute one or more applications using a file system that includes binary files, software libraries, and/or other resources required to execute applications on a guest operating system (e.g., within the virtual computing system 206) or the host operating system 205.

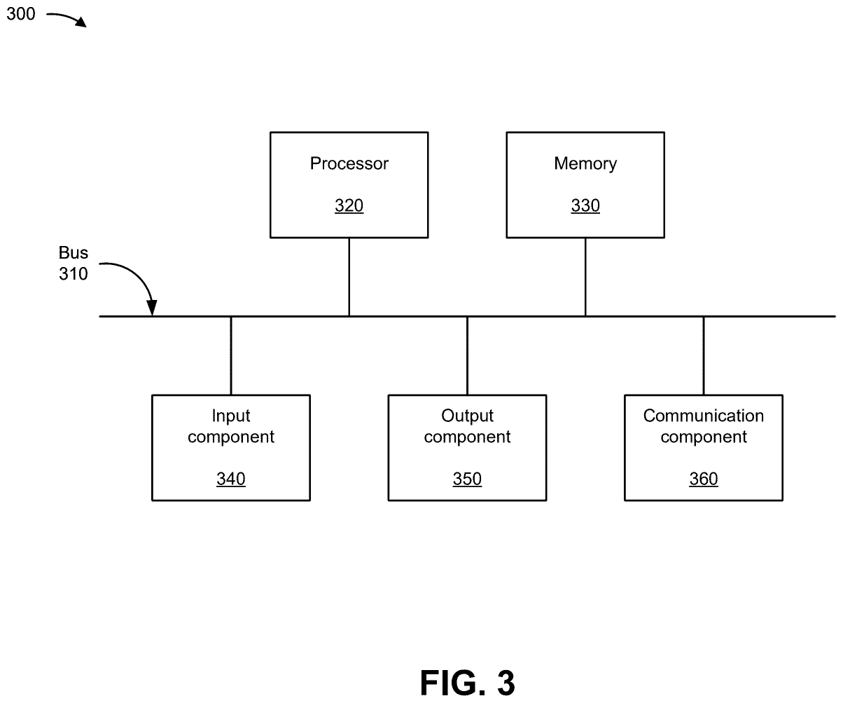

Although the LLM system 110 may include one or more elements 203-213 of the cloud computing system 202, may execute within the cloud computing system 202, and/or may be hosted within the cloud computing system 202, in some implementations, the LLM system 110 may not be cloud-based (e.g., may be implemented outside of a cloud computing system) or may be partially cloud-based. For example, the LLM system 110 may include one or more devices that are not part of the cloud computing system 202, such as the device 300 of FIG. 3, which may include a standalone server or another type of computing device. The LLM system 110 may perform one or more operations and/or processes described in more detail elsewhere herein.

The network 220 includes one or more wired and/or wireless networks. For example, the network 220 may include a cellular network, a public land mobile network (PLMN), a local area network (LAN), a wide area network (WAN), a private network, the Internet, and/or a combination of these or other types of networks. The network 220 enables communication among the devices of the environment 200.

The number and arrangement of devices and networks shown in FIG. 2 are provided as an example. In practice, there may be additional devices and/or networks, fewer devices and/or networks, different devices and/or networks, or differently arranged devices and/or networks than those shown in FIG. 2. Furthermore, two or more devices shown in FIG. 2 may be implemented within a single device, or a single device shown in FIG. 2 may be implemented as multiple, distributed devices. Additionally, or alternatively, a set of devices (e.g., one or more devices) of the environment 200 may perform one or more functions described as being performed by another set of devices of the environment 200.

FIG. 3 is a diagram of example components of a device 300, which may correspond to the user device 105 and/or the LLM system 110. In some implementations, the user device 105 and/or the LLM system 110 may include one or more devices 300 and/or one or more components of the device 300. As shown in FIG. 3, the device 300 may include a bus 310, a processor 320, a memory 330, an input component 340, an output component 350, and a communication component 360.

The bus 310 includes one or more components that enable wired and/or wireless communication among the components of the device 300. The bus 310 may couple together two or more components of FIG. 3, such as via operative coupling, communicative coupling, electronic coupling, and/or electric coupling. The processor 320 includes a central processing unit, a graphics processing unit, a microprocessor, a controller, a microcontroller, a digital signal processor, a field-programmable gate array, an application-specific integrated circuit, and/or another type of processing component. The processor 320 is implemented in hardware, firmware, or a combination of hardware and software. In some implementations, the processor 320 includes one or more processors capable of being programmed to perform one or more operations or processes described elsewhere herein.

The memory 330 includes volatile and/or nonvolatile memory. For example, the memory 330 may include random access memory (RAM), read only memory (ROM), a hard disk drive, and/or another type of memory (e.g., a flash memory, a magnetic memory, and/or an optical memory). The memory 330 may include internal memory (e.g., RAM, ROM, or a hard disk drive) and/or removable memory (e.g., removable via a universal serial bus connection). The memory 330 may be a non-transitory computer-readable medium. The memory 330 stores information, instructions, and/or software (e.g., one or more software applications) related to the operation of the device 300. In some implementations, the memory 330 includes one or more memories that are coupled to one or more processors (e.g., the processor 320), such as via the bus 310.

The input component 340 enables the device 300 to receive input, such as user input and/or sensed input. For example, the input component 340 may include a touch screen, a keyboard, a keypad, a mouse, a button, a microphone, a switch, a sensor, a global positioning system sensor, an accelerometer, a gyroscope, and/or an actuator. The output component 350 enables the device 300 to provide output, such as via a display, a speaker, and/or a light-emitting diode. The communication component 360 enables the device 300 to communicate with other devices via a wired connection and/or a wireless connection. For example, the communication component 360 may include a receiver, a transmitter, a transceiver, a modem, a network interface card, and/or an antenna.

The device 300 may perform one or more operations or processes described herein. For example, a non-transitory computer-readable medium (e.g., the memory 330) may store a set of instructions (e.g., one or more instructions or code) for execution by the processor 320. The processor 320 may execute the set of instructions to perform one or more operations or processes described herein. In some implementations, execution of the set of instructions, by one or more processors 320, causes the one or more processors 320 and/or the device 300 to perform one or more operations or processes described herein. In some implementations, hardwired circuitry may be used instead of or in combination with the instructions to perform one or more operations or processes described herein. Additionally, or alternatively, the processor 320 may be configured to perform one or more operations or processes described herein. Thus, implementations described herein are not limited to any specific combination of hardware circuitry and software.

The number and arrangement of components shown in FIG. 3 are provided as an example. The device 300 may include additional components, fewer components, different components, or differently arranged components than those shown in FIG. 3. Additionally, or alternatively, a set of components (e.g., one or more components) of the device 300 may perform one or more functions described as being performed by another set of components of the device 300.

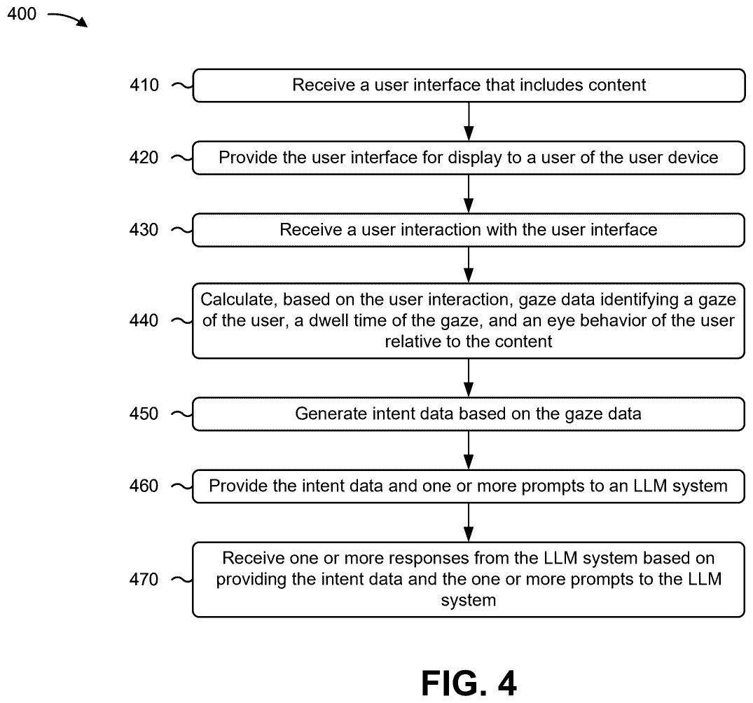

FIG. 4 is a flowchart of an example process 400 for supplementing prompts for an LLM with biometric-based intent data. In some implementations, one or more process blocks of FIG. 4 may be performed by a device (e.g., the user device 105). In some implementations, one or more process blocks of FIG. 4 may be performed by another device or a group of devices separate from or including the device, such as an LLM system (e.g., the LLM system 110). Additionally, or alternatively, one or more process blocks of FIG. 4 may be performed by one or more components of the device 300, such as the processor 320, the memory 330, the input component 340, the output component 350, and/or the communication component 360.

As shown in FIG. 4, process 400 may include receiving a user interface that includes content (block 410). For example, the user device may receive a user interface that includes content, as described above.

As further shown in FIG. 4, process 400 may include providing the user interface for display to a user of the user device (block 420). For example, the user device may provide the user interface for display to a user of the user device, as described above.

As further shown in FIG. 4, process 400 may include receiving a user interaction with the user interface (block 430). For example, the user device may receive a user interaction with the user interface, as described above.

As further shown in FIG. 4, process 400 may include calculating, based on the user interaction, gaze data identifying a gaze of the user, a dwell time of the gaze, and an eye behavior of the user relative to the content (block 440). For example, the user device may calculate, based on the user interaction, gaze data identifying a gaze of the user, a dwell time of the gaze, and an eye behavior of the user relative to the content, as described above. In some implementations, calculating the gaze data includes tracking a horizontal and vertical ratio of the gaze of the user, or calculating midpoint coordinates of the gaze of the user on the content.

As further shown in FIG. 4, process 400 may include generating intent data based on the gaze data (block 450). For example, the user device may generate intent data based on the gaze data, as described above.

As further shown in FIG. 4, process 400 may include providing the intent data and one or more prompts to a large language model (LLM) system (block 460). For example, the user device may provide the intent data and one or more prompts to a large language model (LLM) system, as described above.

As further shown in FIG. 4, process 400 may include receiving one or more responses from the LLM system based on providing the intent data and the one or more prompts to the LLM system (block 470). For example, the user device may receive one or more responses from the LLM system based on providing the intent data and the one or more prompts to the LLM system, as described above. In some implementations, the LLM system is configured to generate the one or more responses based on the intent data and the one or more prompts.

In some implementations, process 400 includes extracting context-specific features from the content based on the gaze data, and generating the intent data based on the gaze data includes generating the intent data based on the gaze data and the context-specific features of the content. In some implementations, process 400 includes refining the intent data by correlating the gaze data with historical interaction data of the user prior to providing the intent data to the LLM system. In some implementations, process 400 includes updating a user profile of the user based on the intent data. In some implementations, process 400 includes calibrating a gaze biometric component of the user device based on an initial interaction of the user with the user device.

In some implementations, process 400 includes modifying the intent data based on a change in the eye behavior of the user and to generate modified intent data, and providing the modified intent data to the LLM system. In some implementations, process 400 includes prioritizing multiple intents of the user, within the intent data, based on weights assigned to the multiple intents. In some implementations, process 400 includes generating an alert based on the intent data indicating an error in the user interaction with the user interface.

In some implementations, process 400 includes receiving feedback data from the LLM system, modifying the intent data based on feedback data and to generate modified intent data, and providing the modified intent data to the LLM system. In some implementations, process 400 includes determining a sequence of user focus areas on the content, and utilizing the sequence of user focus areas to enhance an accuracy of the intent data. In some implementations, process 400 includes associating emotional states of the user with the intent data based on an analysis of the eye behavior of the user.

Although FIG. 4 shows example blocks of process 400, in some implementations, process 400 may include additional blocks, fewer blocks, different blocks, or differently arranged blocks than those depicted in FIG. 4. Additionally, or alternatively, two or more of the blocks of process 400 may be performed in parallel.

As used herein, the term “component” is intended to be broadly construed as hardware, firmware, or a combination of hardware and software. It will be apparent that systems and/or methods described herein may be implemented in different forms of hardware, firmware, and/or a combination of hardware and software. The actual specialized control hardware or software code used to implement these systems and/or methods is not limiting of the implementations. Thus, the operation and behavior of the systems and/or methods are described herein without reference to specific software code—it being understood that software and hardware can be used to implement the systems and/or methods based on the description herein.

As used herein, satisfying a threshold may, depending on the context, refer to a value being greater than the threshold, greater than or equal to the threshold, less than the threshold, less than or equal to the threshold, equal to the threshold, not equal to the threshold, or the like.

To the extent the aforementioned implementations collect, store, or employ personal information of individuals, it should be understood that such information shall be used in accordance with all applicable laws concerning protection of personal information. Additionally, the collection, storage, and use of such information can be subject to consent of the individual to such activity, for example, through well known “opt-in” or “opt-out” processes as can be appropriate for the situation and type of information. Storage and use of personal information can be in an appropriately secure manner reflective of the type of information, for example, through various encryption and anonymization techniques for particularly sensitive information.

Even though particular combinations of features are recited in the claims and/or disclosed in the specification, these combinations are not intended to limit the disclosure of various implementations. In fact, many of these features may be combined in ways not specifically recited in the claims and/or disclosed in the specification. Although each dependent claim listed below may directly depend on only one claim, the disclosure of various implementations includes each dependent claim in combination with every other claim in the claim set. As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiple of the same item.

No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the term “set” is intended to include one or more items (e.g., related items, unrelated items, or a combination of related and unrelated items), and may be used interchangeably with “one or more.” Where only one item is intended, the phrase “only one” or similar language is used. Also, as used herein, the terms “has,” “have,” “having,” or the like are intended to be open-ended terms. Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

In the preceding specification, various example embodiments have been described with reference to the accompanying drawings. It will, however, be evident that various modifications and changes may be made thereto, and additional embodiments may be implemented, without departing from the broader scope of the invention as set forth in the claims that follow. The specification and drawings are accordingly to be regarded in an illustrative rather than restrictive sense.

What is claimed is:

1. A method, comprising:
receiving, by a user device, a user interface that includes content;
providing, by the user device, the user interface for display to a user of the user device;
receiving, by the user device, a user interaction with the user interface;
calculating, by the user device and based on the user interaction, gaze data identifying a gaze of the user, a dwell time of the gaze, and an eye behavior of the user relative to the content;
generating, by the user device, intent data based on the gaze data;
providing, by the user device, the intent data and one or more prompts to a large language model (LLM) system; and
receiving, by the user device, one or more responses from the LLM system based on providing the intent data and the one or more prompts to the LLM system.

2. The method of claim 1, further comprising:
extracting context-specific features from the content based on the gaze data,
wherein generating the intent data based on the gaze data comprises:
generating the intent data based on the gaze data and the context-specific features of the content.

3. The method of claim 1, further comprising:
refining the intent data by correlating the gaze data with historical interaction data of the user prior to providing the intent data to the LLM system.

4. The method of claim 1, further comprising:
updating a user profile of the user based on the intent data.

5. The method of claim 1, wherein the LLM system is configured to generate the one or more responses based on the intent data and the one or more prompts.

6. The method of claim 1, further comprising:
calibrating a gaze biometric component of the user device based on an initial interaction of the user with the user device.

7. The method of claim 1, further comprising:
modifying the intent data based on a change in the eye behavior of the user and to generate modified intent data; and
providing the modified intent data to the LLM system.

8. A user device, comprising:
one or more processors configured to:
receive a user interface that includes content;
provide the user interface for display to a user of the user device;
receive a user interaction with the user interface;
calculate, based on the user interaction, gaze data identifying a gaze of the user, a dwell time of the gaze, and an eye behavior of the user relative to the content;
filter irrelevant gaze data to focus on particular user interactions with the content;
generate intent data based on the gaze data;
provide the intent data and one or more prompts to a large language model (LLM) system; and
receive one or more responses from the LLM system based on providing the intent data and the one or more prompts to the LLM system.

9. The user device of claim 8, wherein the one or more processors are further configured to:
prioritize multiple intents of the user, within the intent data, based on weights assigned to the multiple intents.

10. The user device of claim 8, wherein the one or more processors are further configured to:
generate an alert based on the intent data indicating an error in the user interaction with the user interface.

11. The user device of claim 8, wherein the one or more processors are further configured to:
receive feedback data from the LLM system;
modify the intent data based on feedback data and to generate modified intent data; and
provide the modified intent data to the LLM system.

12. The user device of claim 8, wherein the one or more processors are further configured to:
determine a sequence of user focus areas on the content; and
utilize the sequence of user focus areas to enhance an accuracy of the intent data.

13. The user device of claim 8, wherein the one or more processors are further configured to:
associate emotional states of the user with the intent data based on an analysis of the eye behavior of the user.

14. The user device of claim 8, wherein the one or more processors, to calculate the gaze data, are configured to:
track a horizontal and vertical ratio of the gaze of the user; or
calculate midpoint coordinates of the gaze of the user on the content.

15. A non-transitory computer-readable medium storing a set of instructions, the set of instructions comprising:
one or more instructions that, when executed by one or more processors of a user device, cause the user device to:
receive a user interface that includes content;
provide the user interface for display to a user of the user device;
receive a user interaction with the user interface;
calculate, based on the user interaction, gaze data identifying a gaze of the user, a dwell time of the gaze, and an eye behavior of the user relative to the content;
extract context-specific features from the content based on the gaze data;
generate intent data based on the gaze data and the context-specific features of the content;
provide the intent data and one or more prompts to a large language model (LLM) system; and
receive one or more responses from the LLM system based on providing the intent data and the one or more prompts to the LLM system.

16. The non-transitory computer-readable medium of claim 15, wherein the one or more instructions further cause the user device to one or more of:
update a user profile of the user based on the intent data; or
calibrate a gaze biometric component of the user device based on an initial interaction of the user with the user device.

17. The non-transitory computer-readable medium of claim 15, wherein the one or more instructions further cause the user device to:
modify the intent data based on a change in the eye behavior of the user and to generate modified intent data; and
provide the modified intent data to the LLM system.

18. The non-transitory computer-readable medium of claim 15, wherein the one or more instructions further cause the user device to one or more of:
prioritize multiple intents of the user, within the intent data, based on weights assigned to the multiple intents; or
generate an alert based on the intent data indicating an error in the user interaction with the user interface.

19. The non-transitory computer-readable medium of claim 15, wherein the one or more instructions further cause the user device to:
receive feedback data from the LLM system;
modify the intent data based on feedback data and to generate modified intent data; and
provide the modified intent data to the LLM system.

20. The non-transitory computer-readable medium of claim 15, wherein the one or more instructions further cause the user device to:
determine a sequence of user focus areas on the content; and
utilize the sequence of user focus areas to enhance an accuracy of the intent data.
